(19) United States
(12) Patent Application Publication
(10) Pub. No.: US 2025/0200255 A1
(43) Pub. Date: Jun. 19, 2025

(54) SYSTEM AND METHOD FOR PREDICTING CORROSION RATE IN A PIPE SECTION

(71) Applicant: SHELL USA, INC., Houston, TX (US)

(72) Inventors: Ligang LU, Houston, TX (US); Shun ZHANG, Cambridge, MA (US); Huihui YANG, Houston, TX (US); Kuochen TSAI, Houston, TX (US); Mohamed SIDAHMED, Rio de Janeiro (BR)

(21) Appl. No.: 18/843,390

(22) PCT Filed: Mar. 7, 2023
(86) PCT No.: PCT/EP2023/055684

§ 371 Date: Sep. 3, 2024

Related U.S. Application Data
(60) Provisional application No. 63/318,514, filed on Mar. 10, 2022.

(51) Int. Cl. G06F 30/28; G06F 30/27; G06F 113/08; G06F 113/14

(52) U.S. Cl. CPC G06F 30/28; G06F 30/27; G06F 2113/08; G06F 2113/14

(57) ABSTRACT

A computer-implemented approach has been developed to estimate corrosion rate (100) in a section of a pipe transmitting a corrosive substance. A trained surrogate model (60) is provided to output an estimated value of maximum near-wall velocity (70) of the substance in the pipe section. The estimated value of maximum near-wall velocity (70) is then fed into a computerized electrochemical model (80), together with electrochemical parameters (90) associated with the corrosive substance, which electrochemical model then determines an estimated corrosion rate (100) imposed on the pipe section by the corrosive substance. The surrogate model is trained using results of a full physics-based simulation. Once it has been trained, the surrogate model can generate the estimated value of maximum near-wall velocity (70) much faster than the full physics-based simulation can.

### FIELD OF THE INVENTION

The present invention relates to a computer-implemented method of predicting corrosion rate in a section of a pipe. The present invention further relates to a computer system configured to execute this method. The present invention further relates to training a computer-implemented machine learning model for said computer-implemented method.

### BACKGROUND TO THE INVENTION

Pipelines are widely used for transmission of any substance comprising hydrocarbon fluids (oil and gas). Corrosion is one of the leading causes of pipeline failure, both in onshore and offshore transmission pipelines. Corrosion is caused by oxidation and electrochemical breakdown of the structure of a pipeline section, used in the pipeline to convey the substance. Typically in these pipelines, internal corrosion, caused by the substance being transmitted, presents the dominant corrosion failure mode. Its mitigation requires extensive and reliable predictive modeling.

Various models for pipeline corrosion prediction have been developed. Particularly, physics-based mechanistic corrosion models have demonstrated reliable results. The physics-based mechanistic corrosion models are increasingly enabled by computational fluid dynamics (CFD) simulation, to incorporate the many mechanisms such as chemical kinetics and hydrodynamics. CFD-based modeling allows for flexible numerical characterization of a broad range of corrosion scenarios including different gas species, pipeline geometries and flow conditions, which are

practically infeasible in laboratory and field experiments. However, application in practice tends to be limited by its high computational cost.

To accelerate the corrosion prediction process, it has been proposed to replace the CFD model with a machine-learning enabled surrogate model. Such surrogate model, sometimes also referred to with the terms proxy model or meta model, is a statistically defined model (or function) that replicates the CFD model output over a multidimensional parameter space of selected input parameters. In SPE paper “Machine Learning Based Predictive Models for CO2 Corrosion in Pipelines With Various Bending Angles” (SPE-201275-MS; published in Proceeding of the Annual Technical Conference & Exhibition, October 2020), Huihui Yang et. al. present machine learning surrogate models, based on Light Gradient Boosting Machine (LightGBM) and Multiple Layer Perceptron Neural Network (MLPNN), for the prediction of CO₂ corrosion in aqueous pipelines with different pipe bending angles. A total of seven variables, including flow velocity, pH value, and CO₂ concentration of the substance flowing through the pipe, and pipe inner diameter, pipe bend angle, bend radius, and temperature, are taken as input variables with the corrosion rate as target output variable. A CFD model was used to compute the electrochemical processes occurring at the metal inner surface of the pipe to predict the corrosion rate. As these features have a non-linear relationship with the target output, LightGBM and MLPNN were chosen to statistically map the input variable space to the corrosion rate.

### SUMMARY OF THE INVENTION

In one aspect, there is provided a computer-implemented method of estimating corrosion rate in a section of a pipe transmitting a substance comprising an aqueous phase and corrosive particles, said method comprising:
providing a surrogate model on a computer, which surrogate model has been trained using a plurality of data samples, each data sample comprising a set of one or more geometric parameters describing said section, an inflow velocity of the substance into said section, and a simulated value of a maximum near-wall velocity of the aqueous phase of said substance within said section, wherein the simulated value of the maximum near-wall velocity of any given data sample of the plurality of data samples has been obtained by performing a physics-based simulation based on selected training values of the set of one or more geometric parameters and inflow velocity of the given data sample, and wherein the plurality of data samples is distributed over a preselected multi-dimensional parameter space consisting of said one or more geometric parameters and said inflow velocity, and which surrogate model is configured to output an estimated value of maximum near-wall velocity in response to a selected input query vector comprising query values for each of said one or more geometric parameters and said inflow velocity;
inferring the estimated value of maximum near-wall velocity for a selected flow of a selected substance through a selected pipe section, using said surrogate model, comprising inputting a selected input query vector corresponding to the selected flow of the selected substance through the selected pipe section into said surrogate model, and extracting the estimated maximum near-wall velocity from the surrogate model, wherein said selected input query vector falls within limits of said multi-dimensional parameter space;
feeding said estimated value of near-wall velocity and electrochemical parameters relating to the aqueous phase of said substance into a computerized electrochemical model; and
with the electrochemical model, estimating a corrosion rate based on said estimated value of near-wall velocity and said electrochemical parameters.

In another aspect, there is provided a computer system for estimating corrosion rate in a section of a pipe transmitting a substance comprising an aqueous phase and corrosive particles, said computer system comprising:
at least one processor;
a memory system comprising non-transitory computer-readable memory on which are stored:
a surrogate model configured to output an estimated value of a maximum near-wall velocity, which has been trained using a plurality of data samples, each data sample comprising a set of one or more geometric parameters describing said section, an inflow velocity of the substance into said section, and a simulated value of the maximum near-wall velocity of the aqueous phase of said substance within said section, wherein the simulated value of the maximum near-wall velocity of any given data sample of the plurality of data samples has been obtained by performing a physics-based simulation based on selected training values of the set of one or more geometric parameters and inflow velocity of the given data sample, and wherein the plurality of data samples is distributed over a preselected multi-dimensional parameter space consisting of said one or more geometric parameters and said inflow velocity; and
an electrochemical model configured to estimate a corrosion rate based on said estimated value of the near-wall velocity and electrochemical parameters; and
computer-readable instructions that, when executed by said at least one processor, cause the computer system to:
apply said surrogate model to infer the estimated value of the maximum near-wall velocity for a selected flow of a selected substance through a selected pipe section, comprising inputting into said surrogate model a selected input query vector with query values for the set of one or more geometric parameters and the inflow velocity corresponding to the selected flow of the selected substance through the selected pipe section, and extracting the estimated maximum near-wall velocity from the surrogate model, wherein said selected input query vector falls within limits of said multi-dimensional parameter space;
apply said electrochemical model to the estimated value of maximum near-wall velocity whereby using the electrochemical parameters, wherein the electrochemical parameters relate to the aqueous phase of said substance; and
with the electrochemical model, estimating a corrosion rate based on said estimated value of near-wall velocity and said electrochemical parameters.

In still another aspect, there is provided a computer-implemented method of training a computer model for estimating corrosion rate in a section of a pipe transmitting a substance comprising an aqueous phase and corrosive particles, said method comprising:
providing a physics-based fluid flow simulator on a computer;
generating an initial set of data samples, each data sample of which initial set comprising a set of one or more geometric parameters describing said section, an inflow velocity of the substance into said section, and a simulated value of a maximum near-wall velocity of the aqueous phase of said substance within said section, whereby the simulated value of the maximum near-wall velocity of any given data sample is obtained by performing a physics-based simulation on the physics-based fluid flow simulator, based on selected training values of the set of one or more geometric parameters and inflow velocity of the given data sample, and wherein the initial set of data samples is distributed over a preselected multi-dimensional parameter space consisting of said one or more geometric parameters and said inflow velocity;
training a surrogate model on said computer, by regressing the initial set of data samples, which surrogate model is configured to output an estimated value of maximum near-wall velocity in response to a selected input query vector comprising query values for each of said one or more geometric parameters and said inflow velocity;
providing an electrochemical model on said computer, configured to estimate a corrosion rate based on said estimated value of the near-wall velocity and electrochemical parameters relating to said aqueous phase of said substance; and
coupling said surrogate model to the electrochemical model whereby using the estimated value of maximum near-wall velocity from the surrogate model as input for the electrochemical model

Optionally, non-transitory computer-readable memory of the computer system may contain further computer-readable instructions capable of causing the computer system to execute one or more other processing steps as set forth herein, including those specified in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 schematically shows the geometry of the pipeline section under consideration;

FIG. 2 schematically shows a block diagram of a general implementation of the proposed method;

FIG. 3 schematically shows a block diagram of the active learning workflow;

FIG. 4 shows a graph of maximum uncertainty margin on the vertical axis against number of adaptive sampling iterations on the horizontal axis;

FIG. 5 shows heat maps of estimated corrosion rates (in mm/year) and maximum relative uncertainty margin across a search space after [symbol] one adaptive sampling iteration;

FIG. 6 shows similar heat maps as in FIG. 5 after 7 iterations;

FIG. 7 shows similar heat maps as in FIGS. 5 and 6 after 25 iterations;

FIG. 8 shows the heat map of estimated corrosion rates (in mm/year) after thirty iterations;

FIG. 9 shows a comparative heat map of full model CFD simulations of corrosion rates; and

FIG. 10 shows a correlation graph comparing the surrogate model estimations of Vₘₐₓ/Vᵢₙ on the vertical axis with physics based CFD simulation results of Vₘₐₓ/Vᵢₙ on the horizontal axis.

### DETAILED DESCRIPTION OF THE INVENTION

The person skilled in the art will readily understand that, while the detailed description of the invention will be illustrated making reference to one or more embodiments, each having specific combinations of features and measures, many of those features and measures can be equally or similarly applied independently in other embodiments or combinations.

In the present specification, the term “inflow velocity” (Vᵢₙ) is defined as the average flow velocity across the inlet area. Mathematically, this corresponds to the volumetric flow rate of the substance through the pipe divided by the cross-sectional area available for flow in the pipe section. In case of a circular cross section of the pipe section, the cross-sectional area is equal to 0.25×π×d², wherein d denotes an inner diameter of the circular cross section.

The term “near-wall velocity” is defined as the local free stream velocity directly adjacent to the boundary layer which is in contact with the inside wall of the pipe section. In case of CFD, it is approximated by the first cell average velocity of a cell bound by the inside wall, provided y+ exceeds 30. The “maximum near-wall velocity” (Vₘₐₓ) is the highest value of location-resolved near-wall velocities within the pipe section.

The term “physics-based simulation” is used herein to describe any type of simulation that uses a physics model, as distinct from a data-driven model. A physics model is built on laws and equations of physics, and it generally uses differential equations that are based on conservation laws or other physical principles. In case of fluid flow simulation, physics models may use Navier-Stokes equations and/or Euler equations. Physics-based simulations can be implemented in various forms, including computational fluid dynamics software (CFD) and finite element calculation software. Lattice Bolzmann methods are a recognized class of CFD methods.

A new computer-implemented approach has been developed to estimate corrosion rate in a section of a pipe transmitting a corrosive substance. A trained surrogate model is provided to output an estimated value of maximum near-wall velocity of the substance in the pipe section. The estimated value of maximum near-wall velocity is then fed into a computerized electrochemical model, together with electrochemical parameters associated with the corrosive substance, which electrochemical model then determines an estimated corrosion rate imposed on the pipe section by the corrosive substance.

The surrogate model is trained using results of a full physics-based simulation. Once it has been trained, the surrogate model can generate the estimated value of maximum near-wall velocity much faster than the full physics-based simulation can.

The present invention is based on the surprising discovery that there is a much stronger and more reliable correlation between corrosion rate and the near-wall velocity of a corrosive fluid in a pipe section than for example with shear stress at the wall. The present invention is also based on the finding that a surrogate model can be trained to deliver the near-wall velocity in a given pipe section configuration. The parameter space of input parameters can be much smaller than would be the case for a machine-learning enabled surrogate model that predicts the corrosion rate as output such as published in for example the above-mentioned 2020 SPE paper by Huihui Yang et. al. As a result, the model can be simpler (fewer layers, for example) and training can be done much faster with smaller training data sets.

An additional advantage of the presently proposed approach, which de-couples the fluid flow simulation from the electrochemical model, is that it can fairly easily be applied to other types corrosive substances and/or pipe materials. Alternatively, it relatively less time consuming to train a new surrogate model for the flow aspects for other pipeline section parameters (other shapes, other types of fluids, etc.) than it would be to retrain an entire machine learning enabled model that outputs corrosion rate directly. The surrogate model can be combined with any type of corrosion mechanism.

In the example described herein forth, a Bayesian active learning method has been developed to efficiently and automatically collect CFD samples and construct the predictive model. The term “predictive model” is used herein to describe the combined model of the surrogate model and the electrochemical model. The model in this example is based on Gaussian process regression (GPR). It not only predicts the corrosion rate for a given pipeline design but also provides uncertainty quantification associated with the prediction. An adaptive sampling strategy is applied to automate the sampling process in order to reduce the predictive uncertainty. The exploration technique currently proposed for adaptive sampling is geared to find the next sampling position that will reduce the quantified uncertainty the most. In addition, both physics-based and data-driven dimension reduction methods are employed to simplify the corrosion modeling sample space by orders of magnitude to enable practical applications of CFD-based corrosion predictive modeling.

The following sections introduces the CFD-based corrosion model. The active learning framework is described in detail, and the proposed method is demonstrated in a case involving the prediction of O₂-dominated pipeline corrosion. However, it is to be understood that these are by way of example only. The method can readily be applied to other corrosive particles and pipes, or using other physics-based models to replace CFD.

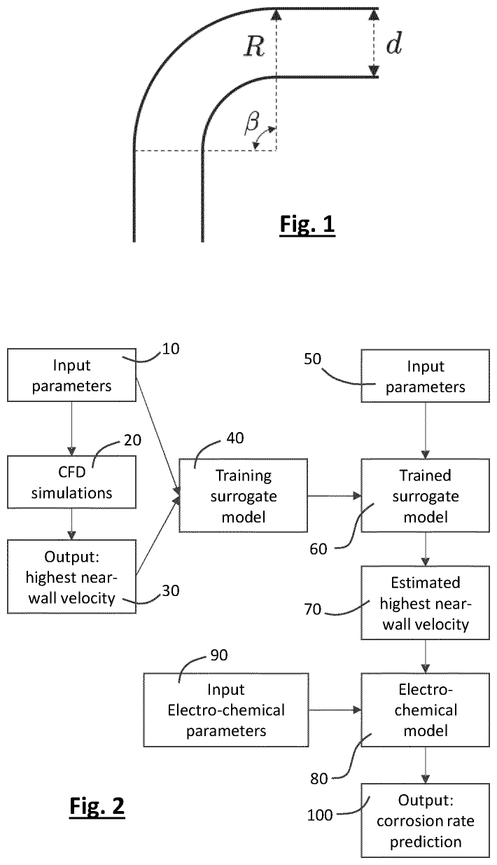

The specific pipe geometry under consideration consists of a pipe section with two straight sections connected by an elbow section, as illustrated in FIG. 1. The straight sections are assumed to be circular cylindric. The geometry is parametrized by inner diameter d, bending angle β, and radius of curvature R.

The overall learning task is to construct the predictive model for pipeline corrosion induced by gases (e.g. CO₂ and O₂) dissolved in aqueous medium. Specifically, a function is sought after that maps from the input variables (including the pipeline design parameters and operating conditions) to an output quantity of interest (i.e. the pipeline corrosion rate), which falls under the broad category of multivariate regression problems. The foremost distinguishing feature of the problem is the tension between the high cost of sampling from the underlying CFD model for the electrochemical process of corrosion and the need to scale up and speed up predictive modeling with budgeted resources in an industrial setting. Hence, a data-scarce scenario should be assumed instead of data being virtually free and unlimited. Additionally, the safety-critical nature of the application under consideration demands uncertainty quantification and/or error estimation of the model prediction, to facilitate engineering and business decision making.

The predictive model combines electrochemistry and near-wall mass transport for aqueous flow inside a steel pipeline of an elbow-shaped geometry. The model has been developed and validated for various corrosion-inducing gases such as CO₂ and O₂. The corrosion is assumed to be mainly driven by processes involving chemical reactions related to the solution and electrochemistry. For example, the following reactions dominate corrosion for water flow inside a steel pipeline with dissolved CO₂ and O₂, including solution chemistry:

CO₂+H₂O⇔H₂CO₃

H₂CO₃⇔HCO₃⁻+H⁺

HCO₃⁻⇔CO₃²⁻+H⁺

anodic reaction:

Fe→Fe₂⁺+2e⁻

and cathodic reactions:

2H₂CO₃+2e⁻→H₂+2HCO₃⁻

2HCO₃⁻+2e⁻→H₂+2CO₃²⁻

O₂+2H₂O+4e⁻→4OH⁻

These reactions are combined with surface mass transport limitation equations to determine the rate of corrosion. In the CFD model, the Reynolds-averaged Navier-Stokes equations are employed with a k-ϵ turbulence model for fully turbulent flow inside the pipe section. This study focuses on single-phase flow, while two-phase oil-water flow is also supported albeit at a higher computational cost. The model may suitably be implemented and executed using ANSYS Fluent 18.1 (Ansys, Inc. Canonsburg, PA 15317, U.S.A).

FIG. 2 schematically summarizes the approach with a block diagram. At 10, a set of one or more geometric parameters describing the pipe section and the inflow velocity of the substance into the pipe section are provided and fed to the CFD model. The geometric parameters may comprise inner diameter d, bending angle, and radius of curvature R. At 20, CFD simulations are run and at 30 a highest (maximum) near-wall velocity value is determined on basis of the CFD simulations for a variety of values of input parameters. This may require some post processing of the full CFD solution. The CFD model thus is only used to generate highest velocity value within each specific set of input variations: inlet velocity, pipe ID, pipe bend angle and pipe bend radius. The output is the highest simulated velocity value near the wall in the geometry defined by pipe ID, pipe bend angle and pipe bend radius.

Samples of CFD generated data, i.e. the simulated maximum near-wall velocity (one output) together with the specific values of the input parameters (the set of geometric parameters and inflow velocity) which led to the simulated maximum near-wall velocity, are then passed a machine learning (ML) model for training at 40. This will be the surrogate model.

Still referring to FIG. 2, an input query vector comprising query values for each of said one or more geometric parameters and said inflow velocity within the range of the input parameters can then be provided at 50. Such values may for example be dictated by certain design hypotheses for a pipeline. At 60, the query vector can then be fed to the surrogate model, embodied as the trained ML model which is created at 40, to predict the highest near wall velocity value (at 70) for that specific input query vector. This replaces doing more (time-consuming) CFD simulations on the input query, and this way a large variation of input query vectors can be investigated in a much shorter amount of time.

Any artificial neural network may be employed as the ML model for the surrogate model. A feed forward artificial neural network will typically suffice. The neural network may be fully connected, and comprise two, or more, hidden layers. Preferably, however, a Gaussian Process Regression (GPR) model is employed, one of its advantages being that it has the ability to provide uncertainty quantification on the predictions. Uncertainty estimates may be advantageously employed to drive an adoptive data sampling strategy, as will be further explained below. GPR is a suitable regression method, but other types of non-parametric regression may be employed, instead, preferably those that provide uncertainty quantification with the predictions.

At 80, the estimated maximum near-wall velocity value(s) are fed to the electrochemical model, together with input parameters 90 relevant for the electrochemical model. These additional electrochemical input parameters may be included in the input query vector, but they are not used by the surrogate model at 60. The electrochemical input parameters 90 generally may include parameters associated with the nature of the substance in the pipe section. This typically includes temperature of the substance type of corrosive particle in the substance, and partial pressure of each type of corrosive particle present in the substance, and the pH of the substance. At 100, the electrochemical model outputs the estimated corrosion rate corresponding to the specific query vector.

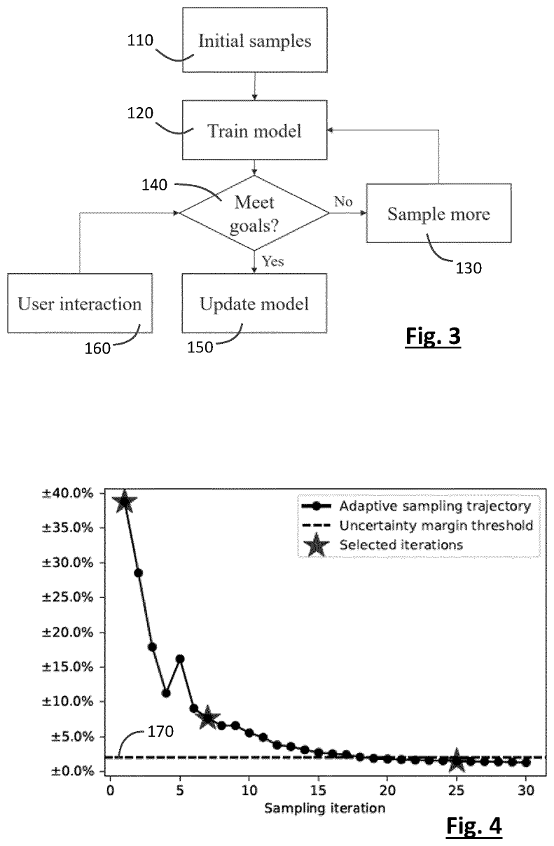

An active learning approach is adopted to sample training data from the costly physics based CFD model in a manner that optimizes the value of collected data given limited resources and minimizes human efforts for modeling and sampling. An example workflow of the learning process is illustrated in FIG. 3. First the model is trained at 120 using an initial set of training data samples 110. The model training (regression modeling) 120 and data sampling 130 are then executed iteratively in a feedback loop. The process is paused upon meeting certain termination conditions at 140, in which case the model is updated at 150. Termination conditions may be prescribed based on resource limitation, uncertainty tolerance and user request. The model training is triggered again when new resources are allocated or user requests 160 are registered, prompting the model still remains to be improved. Such user request may involve a change in termination conditions at 140.

The active learning method used in this example employs a predictive model based on Gaussian process regression, combined with a sampling strategy driven by greedy exploration and user interaction.

### Gaussian Process Regression

Gaussian process regression (GPR) models are nonparametric kernel-based probabilistic models. GPR is associated with flexible kernel formulation, allowing for representing complex nonlinear multivariate functions. In addition, an underlying Bayesian formalism quantifies the uncertainty associated with the model prediction, and a measure of merit for the predictive model is provided, which can drive further sampling as part of the active learning framework. The GPR formulation employed is briefly described herein. A more detailed exposition is available in open references including Rasmussen, C. E. band Williams, C. K. I., “Gaussian Processes for Machine Learning”, MIT Press., Cambridge, Massachusetts, USA (ISBN 026218253X) (2006).

The Gaussian process (GP) is a stochastic process that characterizes the distribution of functions in a function space determined by the kernel (a symmetric positive definite function k(⋅, ⋅): [symbol] ^{d}× [symbol] ^{d}→ [symbol] ⁺). Regression based on GP (i.e. GPR) amounts to homing in on a specific distribution of functions that accounts for observed samples (i.e. a posterior distribution conditioned upon data). For a true model mapping x→y from input (of X∈ [symbol] ^{d} dimension d) to output y∈ [symbol] and a corresponding dataset [symbol] ={(xᵢ, yᵢ)}ᵢ₌₁ⁿ for i=1 to n samples, GPR seeks a function approximation f: x→f(x). The symbol [symbol] indicates the set of real numbers, [symbol] ^{d} is the real number space of dimension d, and [symbol] ⁺ is the set of positive real numbers. By the definition of GP, the labeled data and a pointwise prediction jointly f(x*) (for any x*∈ [symbol] ^{d}) follow a multivariate Gaussian distribution (assuming a zero mean without loss of generality),

$$[ \begin{matrix}y \\ {y}^{*}\end{matrix} ] \sim 𝒩 ( [ \begin{matrix}0 \\ 0\end{matrix} ] , [ \begin{matrix}K & {K}^{*} \\ {K}^{{*}^{T}} & {K}^{**}\end{matrix} ] ) \qquad ( Eq . 1 )$$

where y∈ [symbol] ⁿ, X∈ [symbol] ^{n×d} and

$$y = [ \begin{matrix}{y}_{1} \\ {y}_{2} \\ ⋮ \\ {y}_{n}\end{matrix} ] , X = [ \begin{matrix}– {x}_{1} – \\ – {x}_{2} – \\ ⋮ \\ – {x}_{n} –\end{matrix} ] , \begin{matrix}K = k ( X , X ) ∈ {ℝ}^{n \times n} \\ {K}^{*} = k ( X , {x}^{*} ) ∈ {ℝ}^{n \times 1} \\ {K}^{**} = k ( {x}^{*} , {x}^{*} ) ∈ ℝ\end{matrix}$$

It can be derived that the model prediction f(x*) is conditionally distributed given the data (X and y) as follows:

$$f ( {x}^{*} ) \vert X , y \sim 𝒩 ( {μ}^{*} , {Σ}^{*} ) \qquad ( Eq . 2 )$$

$$and$$

$${μ}^{*} = {K}^{{*}^{T}} {K}^{- 1} y , {Σ}^{*} = {K}^{**} - {K}^{{*}^{T}} {K}^{- 1} {K}^{*} \qquad ( Eq . 3 )$$

in which [symbol] denotes the normal Gaussian operator and k is a kernel (covariance matrix). The mean μ* is the regression output predicted by GPR for input x*, and is endowed with uncertainty quantified in terms of the covariance matrix Σ* (i.e. the variance σ²(x*) for scalar-valued prediction f(x*)).

The GP kernel k(⋅,⋅;θ), parametrized by θ∈ [symbol] ^{p} (of dimension p), is defined as a sum of Matèrn 5/2 (with anisotropic length scales) and white noise kernels. The Matèrn 5/2 kernel component models twice-differentiable functions and reflects the assumption of smoothness in the underlying true model being approximated, while anisotropic length scales allow for multiscale features attributed to different input dimensions. The white noise kernel component accounts for random noises in the sampling process. For example, the numerical noise arising from post-processing the CFD results (which are dependent on the underlying numerical discretization and computational grid) to obtain the output data is considered random. The GP model parameter θ of the specific kernel employed here encodes the length scales and the variance of the Matèrn 5/2 kernel and the noise level of the white noise kernel. For each GP model, the parameter θ is tuned using maximum likelihood estimation (MLE), intended to best explain the given dataset [symbol] .

$${θ}^{*} = {arg max}_{θ} p ( y \vert X , θ ) . \qquad ( Eq . 4 )$$

The GPR prediction in Eq. (2) uses the kernel with optimized parameter θ*.

### Adaptive Sampling

In the active learning framework described herein, new samples are collected adaptively and are used to continually update the model. This process forms a feedback loop as illustrated in FIG. 3, and is intended to control the uncertainty in model prediction. At the same time any optional user-initiated queries may be met as well. The latter consideration is motivated by practical usage of predictive modeling in industrial applications. The end user (for example, a corrosion engineer in this case) often has certain domain-specific knowledge or is bound by certain tasks when using the predictive model. These prior circumstances may favor interests in a certain subset of the design/input space, that is not readily reflected in an application-agnostic sampling strategy, for example, driven by only variance reduction. The sampling strategy is formulated to balance both variance reduction and user-intention embedding. Given a model trained upon an existing dataset, a new sample label

y′ is collected (by executing the physics-based CFD model) for the input x′ that maximizes the utility function:

$$u ( x ) = {σ}^{2} ( x ) - \frac{λ}{{N}_{q}} {\sum }_{j = 1}^{{N}_{q}} {‖ x - {x}_{j} ‖}_{2}^{2} \qquad ( Eq . 5 )$$

where σ²(x) is the variance for GPR prediction f(x), {xⱼ}j₌₁^{N}^{_{q}} are j=1 to N_{q} active input queries of interest to the λ∈ [symbol] ⁺ user, and serves as a tunable parameter. The deviation from user queries in the (normalized) input space is measured by the Euclidean distance (i.e. an L₂ norm). For λ=0, the sampling strategy reduces to an exploration without-exploitation approach in Bayesian optimization.

The utility function u (x) requires only negligible cost to evaluate with the GPR model compared to the full physics-based (e.g CFD) model, and hence allows for a greedy search for the utility maximizing input x′ for which the subsequent sample is taken.

### Dimension Reduction

Dynamical similarity in the fluid dynamics problem can be leveraged to accomplish a further reduction in the number of dimensions needed in the input space to train the surrogate model. Three of the geometrical parameters (d, R, and Vᵢₙ) and the output parameter (Vₘₐₓ) are dimensional in the sense that they have units in the dimensions length and time. Another parameter which is used in the physics-based model, v, which stands for kinematic viscosity of the substance, also has a dimension (units of m²/s). Based on Buckingham-II theorem for dimensional analysis, the original physics based problem can be formulated equivalently using only three dimensionless variables by using ratios of two dimensional variables. The following functional dependence is used:

$$β , \frac{d}{R} , {Re}_{d} ↦ \frac{{V}_{max}}{{V}_{in}} . \qquad ( Eq . 6 )$$

In this dependence, d/R, Re_{d} and Vₘₐₓ/Vᵢₙ are postulated dimensionless variables respectively corresponding to non-dimensionalizing R, v and Vₘₐₓ. Re_{d} corresponds to the Reynolds number based on the pipe inner diameter, defined to be dVₘₐₓ/v. The input parameter space thus reduces to three-dimensional using the dimensionless formulation.

Data driven methods have been employed to explore additional opportunities for further dimension reduction, and it has been found for the case described Re_{d} below that had a relatively small influence Vₘₐₓ/Vᵢₙ on. Hence, it was possible to simplify the input parameters to β and d/R only. Similar data-driven sensitivity analysis may be employed for other cases and geometries as well.

### Practical Demonstration

The methodology presented herein has been tested. The training of the surrogate CFD model was initiated with only four initial samples 110, which were randomly selected within a search space formulated as [symbol] ={(β,d/R)|β∈[0°, 180°], d/R∈[0, 2]}. After running the initial four samples, the GPR and adaptive sampling procedures were executed iteratively until the terminal condition at 140 was met. To determine

the convergence of the learning process, a relative uncertainty margin defined as

$${max}_{x ∈ 𝒮} \frac{1.96 σ ( x )}{f ( x )} \qquad ( Eq . 7 )$$

was used. Here, f(x) refers to the output of interest (i.e. the corrosion rate, which is strictly positive) and σ(x) refers to the associated standard deviation. With this equation, 1.96 σ(x) measures the half-range of the 95% confidence interval.

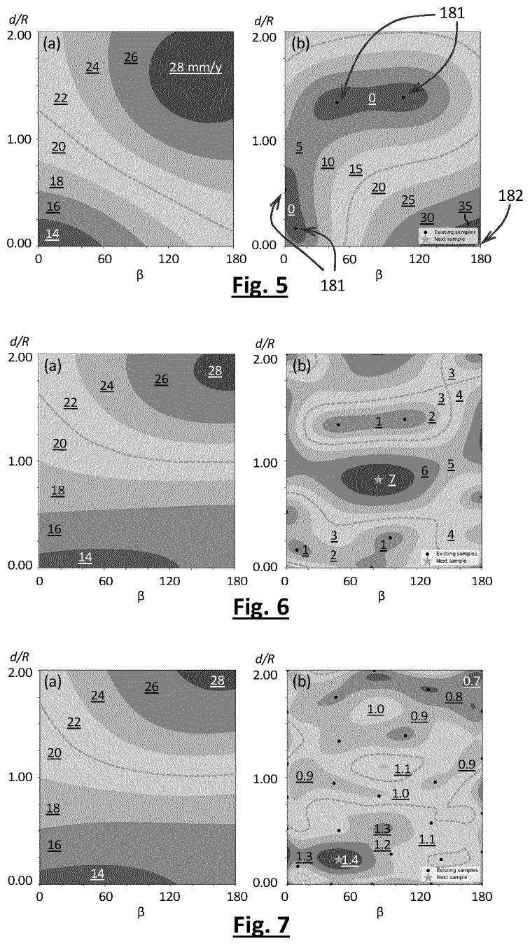

The active learning method was executed for thirty learning-sampling iterations. The convergence of the uncertainty margin as defined in Eq. (7) is illustrated in FIG. 4. The dots represent the uncertainty margin for the successive iterations. Three iterations (labeled with stars instead of dots) have been selected for a closer illustration in FIGS. 5 to 7. The dashed horizontal line 170 marks a selected uncertainty threshold of 2%. This threshold can be chosen. It can be seen that the initial uncertainty margin quickly reduced to below the threshold of 2% after 20 iterations where only 23 samples are needed.

Results from the three selected iterations labeled with stars in FIG. 4 are shown in detail in FIGS. 5-7. Each of these figures comprise two heat maps. Heat map (a) on the left shows the estimated corrosion rates (in mm/year) across the entire search space [symbol] of d Ron the vertical axis and β on the horizontal axis. The numbers inserted in the grade shaded zones indicate the lower limit of ranges of estimated corrosion rates. E.g. the zone labeled 14 corresponds to the area in the heat map where the corrosion rate is estimated to be in the interval [14,16) wherein a “[-type” bracket indicates lower value including and a “)-type” bracket indicates upper value excluding. The zone with the highest estimated corrosion rate corresponds to [28-30). Heat map (b) on the right indicates the maximum relative uncertainty in the estimations of heat map (a) in %. The same convention is used for the intervals as in heat map (a). In FIG. 5 (b), for example, the area of lowest maximum uncertainty corresponds to an uncertainty interval of [0%, 5%) and the area of the highest maximum uncertainty corresponds to an uncertainty interval of [35%, 40%). FIG. 5 shows the heat maps after one adaptive sampling iteration, indicated in FIG. 4 by the first starred symbol. FIG. 6 shows the same heat maps after 7 adaptive iterations, and FIG. 7 after 25 adaptive iterations.

The dark dots indicate the existing samples on which the GPR model was trained. The four initial samples 181 are seen in heat map (b) of FIG. 5. Not surprisingly, the four initial samples 181 are within the lowest uncertainty areas labeled 0. The next sampling point of the next sample x′ for the next iteration is indicated at 182. The location in the search space is suitably determined by the greedy variance reduction method (with λ=0). In this case, it resulted at or near the point in the search space where the uncertainty is the highest, which in this case is in the point at coordinate (β, d R)=(180, 0.00). It is observed that the adaptively collected samples are distributed in the input parameter space in an anisotropic and unstructured manner.

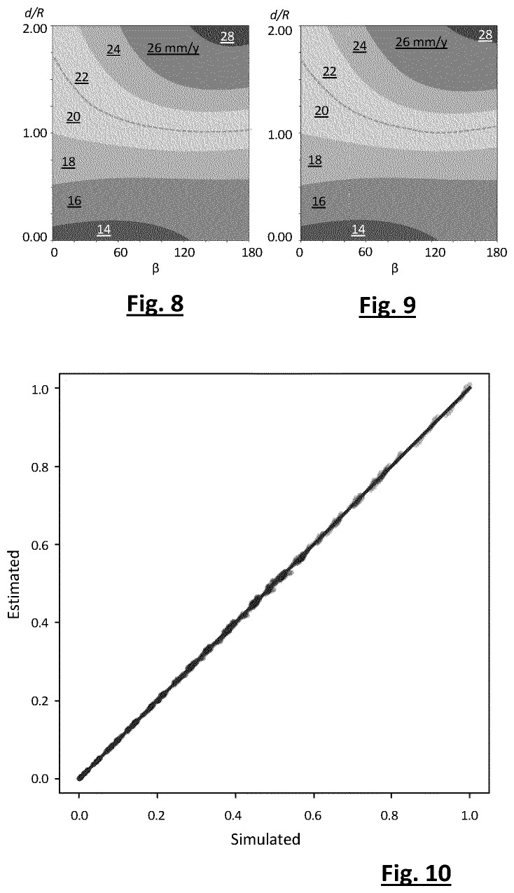

In FIGS. 6 and 7 is can clearly be seen that the estimations converge rapidly. The uncertainty intervals decrease and the mutations that occur in the heat maps (a) become smaller and smaller. FIG. 8 shows the estimated corrosion rates at the end of the active learning, after thirty iterations, and this figure is visually identical to heat map (a) of FIG. 7.

FIG. 9 shows the “true” heat map based on full CFD simulations of the corrosion rates across the search space. By comparing FIG. 9 to FIG. 8, it can be seen that at the end of the active learning iterations (thirty sampling iterations), the trained model matches the underlying true model (sampled at high resolution for illustration) very closely. The predictive accuracy of the actively trained model is also verified in FIG. 10 by comparing the surrogate model estimations of Vₘₐₓ/Vᵢₙ (i.e. the predicted regression target) on the vertical axis with physics based CFD simulation results of Vₘₐₓ/Vᵢₙ (the full physics based model data) on the horizontal axis. The values are normalized to [0,1]. A dot swarm consisting of 1188 samples is shown, against a straight line representing the perfect prediction where all estimations equal the simulations. The coefficient of determination (R²) is 0.9987, which indicates a decent performance of the model prediction. The final actively trained model was trained on only 33 samples, and provides uncertainty quantification. This marks a significant efficiency improvement compared to manually designed sampling matrices from the dimensional input parameter space choices that were initially used in earlier versions.

All steps and machine learning models may suitably be integrated under one common user interface and automatically executable in the computer system so that manual execution of subsequent models is not necessary. All sequential deep learning models are applied to the data by the computer system without human intervention.

The methodologies and systems described above can be used practically in pipeline design to minimize the corrosion risk. It reduces the CFD simulation needs during the design process and thus is capably of exploring larger design spaces in a given amount of time. It can also be used in predictive maintenance to monitor/predict if some spots in the pipeline have significant corrosion risk. Herewith it can be avoided that operations are stopped prematurely for inspection while at the same time reducing the risk of acute corrosion-induced failures. Accordingly, pipeline sections can be built and/or maintained in accordance with results provided by operating the methodologies and systems described herein.

The pipe sections discussed above may be included in any kind of piping that conveys corrosive substances, including pipelines, such as oil and gas pipelines, subsea cross-over lines, piping in a chemical plant or refinery, etc.,

The person skilled in the art will understand that the present invention can be carried out in many various ways without departing from the scope of the appended claims.

1. A computer-implemented method of estimating corrosion rate in a section of a pipe transmitting a substance comprising an aqueous phase and corrosive particles, said method comprising:
providing a surrogate model on a computer, which surrogate model has been trained using a plurality of data samples, each data sample comprising a set of one or more geometric parameters describing said section, an inflow velocity of the substance into said section, and a simulated value of a maximum near-wall velocity of the aqueous phase of said substance within said section, wherein the simulated value of the maximum near-wall velocity of any given data sample of the plurality of data samples has been obtained by performing a physics-based simulation based on selected training values of the set of one or more geometric parameters and inflow velocity of the given data sample, and wherein the plurality of data samples is distributed over a preselected multi-dimensional parameter space consisting of said one or more geometric parameters and said inflow velocity, and which surrogate model is configured to output an estimated value of maximum near-wall velocity in response to a selected input query vector comprising query values for each of said one or more geometric parameters and said inflow velocity:
inferring the estimated value of maximum near-wall velocity for a selected flow of a selected substance through a selected pipeline section, using said surrogate model, comprising inputting a selected input query vector corresponding to the selected flow of the selected substance through the selected pipeline section into said surrogate model, and extracting the estimated maximum near-wall velocity from the surrogate model, wherein said selected input query vector falls within limits of said multi-dimensional parameter space:
feeding said estimated value of near-wall velocity and electrochemical parameters relating to the aqueous phase of said substance into a computerized electrochemical model; and
with the electrochemical model, estimating a corrosion rate based on said estimated value of near-wall velocity and said electrochemical parameters.

2. The computer-implemented method of claim 1, wherein said surrogate model is a machine-learning enabled surrogate model.

3. The computer-implemented method of claim 1, wherein said surrogate model comprises an artificial neural network.

4. The computer-implemented method of claim 3, wherein the artificial neural network employs Gaussian progress regression.

5. The computer-implemented method of claim 1, wherein said selected pipe section comprises an elbow section characterized by a bend radius R and a bending angle β, and wherein the selected pipe section has a circular cross section that is constant along said bending angle, which circular cross section is characterized by an inner diameter d, and wherein said one or more geometric parameters consist of R, d, and β.

6. The computer-implemented method of claim 1, wherein said electrochemical parameters comprises: type of corrosive particles, partial pressure for each type of said corrosive particles in said substance, pH value of the aqueous phase of said substance, and temperature T of said substance.

7. The computer-implemented method of claim 1, wherein said physics-based simulation comprises a computational fluid dynamics (CFD) model.

8. The computer-implemented method of claim 1, wherein the selected pipe section comprises carbon steel.

9. The computer-implemented method of claim 1, wherein the corrosive particles comprise at least one of the group consisting of CO₂, O₂, and H₂S.

10. The computer-implemented method of claim 1, wherein the simulated value of the maximum near-wall velocity is defined exclusively in said aqueous phase of the substance.

11. A computer system for estimating corrosion rate in a section of a pipe transmitting a substance comprising an aqueous phase and corrosive particles, said computer system comprising:
at least one processor:
a memory system comprising non-transitory computer-readable non-transient memory on which are stored:
a surrogate model configured to output an estimated value of a maximum near-wall velocity, which has been trained using a plurality of data samples, each data sample comprising a set of one or more geometric parameters describing said section, an inflow velocity of the substance into said section, and a simulated value of the maximum near-wall velocity of the aqueous phase of said substance within said section, wherein the simulated value of the maximum near-wall velocity of any given data sample of the plurality of data samples has been obtained by performing a physics-based simulation based on selected training values of the set of one or more geometric parameters and inflow velocity of the given data sample, and wherein the plurality of data samples is distributed over a preselected multi-dimensional parameter space consisting of said one or more geometric parameters and said inflow velocity; and
an electrochemical model configured to estimate a corrosion rate based on said estimated value of the near-wall velocity and electrochemical parameters; and
computer-readable instructions that, when executed by said at least one processor, cause the computer system to:
apply said surrogate model to infer the estimated value of the maximum near-wall velocity for a selected flow of a selected substance through a selected pipe section, comprising inputting into said surrogate model a selected input query vector with query values for the set of one or more geometric parameters and the inflow velocity corresponding to the selected flow of the selected substance through the selected pipe section, and extracting the estimated maximum near-wall velocity from the surrogate model, wherein said selected input query vector falls within limits of said multi-dimensional parameter space:
apply said electrochemical model to the estimated value of maximum near-wall velocity whereby using the electrochemical parameters, wherein the electrochemical parameters relate to the aqueous phase of said substance; and
with the electrochemical model, estimating a corrosion rate based on said estimated value of near-wall velocity and said electrochemical parameters.

12. A computer-implemented method of training a computer model for estimating corrosion rate in a section of a pipe transmitting a substance comprising an aqueous phase and corrosive particles, said method comprising:
providing a physics-based fluid flow simulator on a computer:
generating an initial set of data samples, each data sample of which initial set comprising a set of one or more geometric parameters describing said section, an inflow velocity of the substance into said section, and a simulated value of a maximum near-wall velocity of the aqueous phase of said substance within said section, whereby the simulated value of the maximum near-wall velocity of any given data sample is obtained by performing a physics-based simulation on the physics-based fluid flow simulator, based on selected training values of the set of one or more geometric parameters and inflow velocity of the given data sample, and wherein the initial set of data samples is distributed over a preselected multi-dimensional parameter space consisting of said one or more geometric parameters and said inflow velocity:
training a surrogate model on said computer, by regressing the initial set of data samples, which surrogate model is configured to output an estimated value of maximum near-wall velocity in response to a selected input query vector comprising query values for each of said one or more geometric parameters and said inflow velocity:
providing an electrochemical model on said computer, configured to estimate a corrosion rate based on said estimated value of the near-wall velocity and electrochemical parameters relating to said aqueous phase of said substance; and
coupling said surrogate model to the electrochemical model whereby using the estimated value of maximum near-wall velocity from the surrogate model as input for the electrochemical model.

13. The computer-implemented method of claim 12, wherein said regressing comprises Gaussian process regression.

14. The computer-implemented method of claim 12, wherein a regression uncertainty of the surrogate model is determined across the preselected multi-dimensional parameter space, said method further comprising:
selectively generating at least one additional data sample using training values of the set of one or more geometric parameters and inflow velocity corresponding to an area in the multi-dimensional parameter space which has a relatively high regression uncertainty compared to other areas in the multi-dimensional parameter space;
further training of the surrogate model using the at least one additional data sample.

15. The computer-implemented method of claim 14, further comprising repeating said selectively generating and said further training until a terminal condition is met.
